(19) United States
(12) Patent Application Publication
(10) Pub. No.: US 2016/0318168 A1
(43) Pub. Date: Nov. 3, 2016

(54) METHOD FOR MAKING BICYCLE FOLDING TOOLS

(71) Applicant: Tuo-Jen Chen, Taichung (TW)

(72) Inventor: Tuo-Jen Chen, Taichung (TW)

(21) Appl. No.: 14/697,630

(22) Filed: Apr. 28, 2015

(51) Int. Cl. B25F 1/00

(52) U.S. Cl. CPC B25F 1/00

(57) ABSTRACT

A method for making bicycle folding tools includes a step of preparing: preparing a board with a pre-set length; a step of punching: punching the first end of the board to form a function end, and the board with the function end being a semi-finished product; a step of bending: bending the semi-finished product to form a connection end which has a hole defined therethrough, and a step of forming a final product: a final product being formed with the function end and the connection end on two ends thereof. The folding tools have consistent shape and quality so as to save space when assembling the folding tools into a bicycle folding tools pack. The folding tools are light in weight and compact.

### BACKGROUND OF THE INVENTION

1. Fields of the Invention

The present invention relates to a method for making a folding tool, and more particularly, to a method for making bicycle folding tools.

2. Descriptions of Related Art

The conventional bicycle folding tool pack 10 comprises multiple folding tools which have different functions, and these folding tools are pivotably connected to each other to form a tool pack. As shown in FIG. 1, the conventional bicycle folding tool pack 10 includes two boards 11 between which multiple folding tools 12 are pivotably connected. The folding tools 12 are parallel to each other as shown in FIG. 2.

However, these folding tools 12 mostly are driver bits which are small and have single function. When larger folding tools are involved, such as a chain detachment tool 13 or carbon-dioxide nozzle is involved in the bicycle folding tool pack 10, as shown in FIG. 3, the space will be not sufficient for other folding tools 12.

FIG. 4 shows that the two boards of the bicycle folding tool pack 17 are Y-shaped so that there is a wider space for accommodating larger folding tools between the two boards. Nevertheless, the Y-shaped boards increase the size of the bicycle folding tool pack 17 and do not improve the existed shortcomings.

FIG. 5 shows yet another bicycle folding tool pack 20 which has two boards 21 with two pivots 22 connected therebetween so that the folding tools 23, 25, 26 are pivotably connected to the pivots 22. These folding tools 23, 25, 26 are parallel and can be made according to users' needs. However, the folding tool 23 has a wider top portion than others, so that the wider top portion occupies a larger space and restricts other folding tools to be connected to the bicycle folding tool pack 20.

Furthermore, in order to well position the folding tools 23, 25, 26, multiple separation tubes 27 are used to be mounted to the pivots so as to separate the folding tools 23, 25, 26. These separation tubes 27 each have a passage 271 through which the folding tools 23, 25, 26 extend, such that the separation tubes 27 are connected to each other to position the folding tools 23, 25, 26. However, the separation tubes 27 actually occupy the space and the problem for the limitation of the space is not improved.

The present invention intends to provide a bicycle folding tools that improve the shortcomings mentioned above.

### SUMMARY OF THE INVENTION

The present invention relates to a method for making bicycle folding tools, and the method comprises the following steps:
a step of preparing: preparing a board with a pre-set length;
a step of punching: punching a first end of the board to form a function end, the board with the function end being a semi-finished product which has the function end formed at a first end thereof;
a step of bending: bending a second end of the semi-finished product to form a connection end which has a hole defined therethrough, and
a step of forming a final product: a final product being formed with the function end and the connection end on two ends thereof.

Preferably, the method of the present invention further comprises a sub-step of punching by using molds after the step of bending, the molds secure and form the final product with consistent shape and structure.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional bicycle folding tool pack;

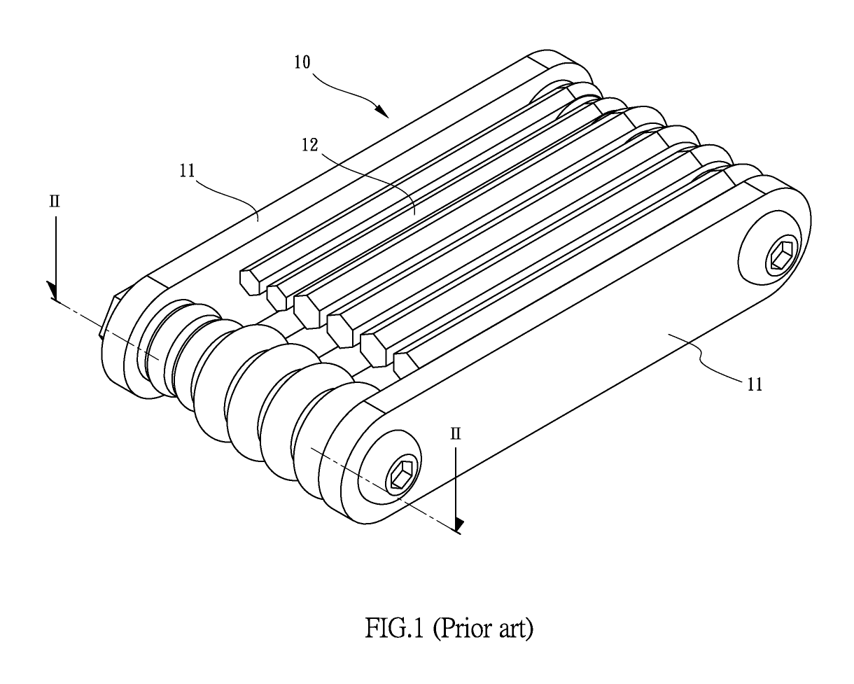

FIG. 2 is a cross sectional view of the conventional bicycle folding tool pack;

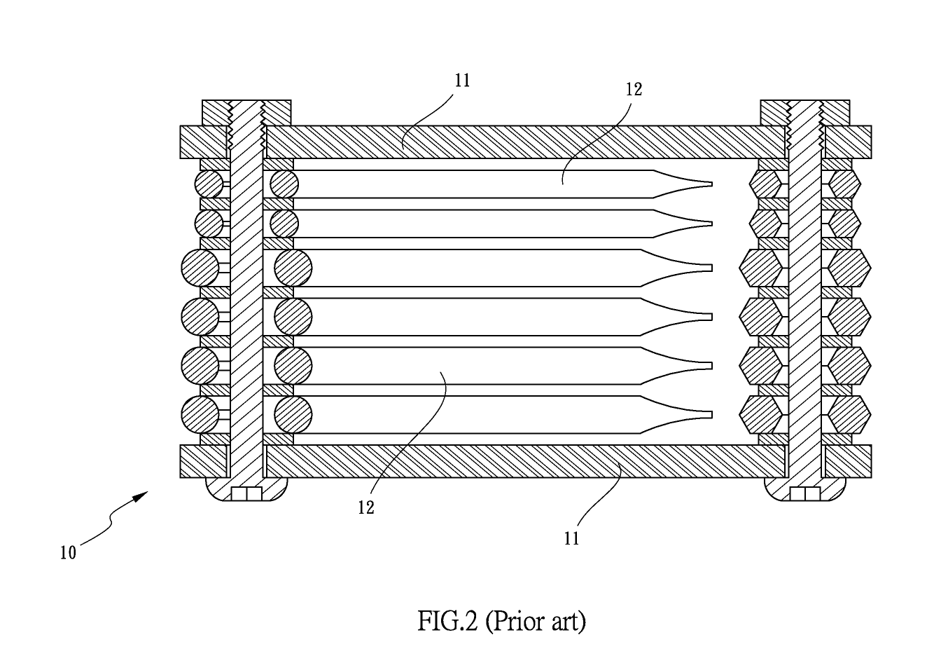

FIG. 3 shows that the conventional bicycle folding tool pack includes at least one large folding tool;

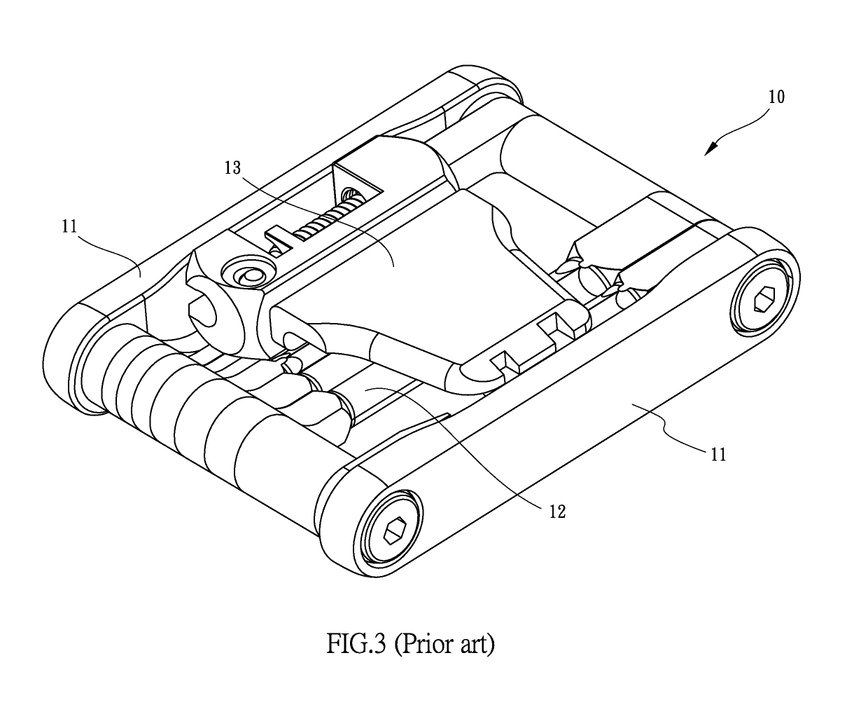

FIG. 4 is a perspective view to show another conventional bicycle folding tool pack;

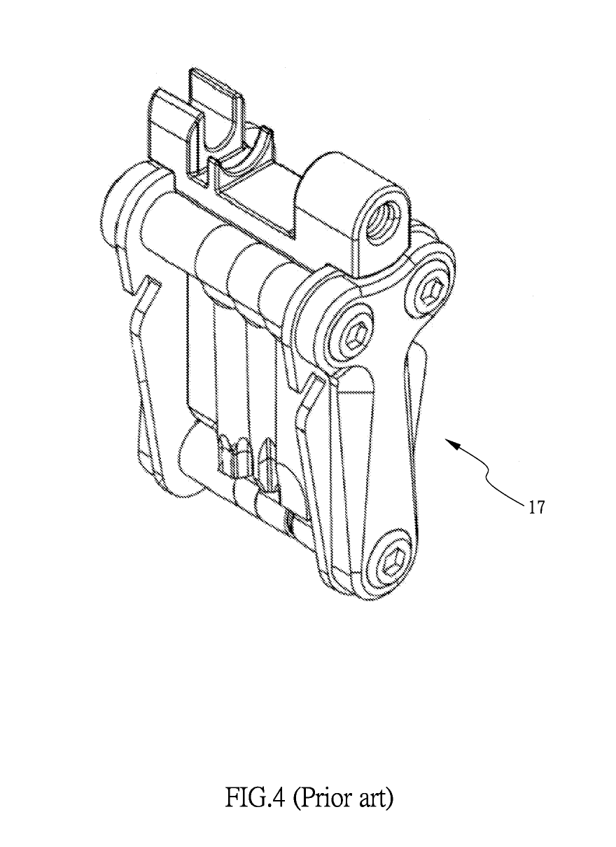

FIG. 5 is an exploded view to show the conventional bicycle folding tool pack in FIG. 4;

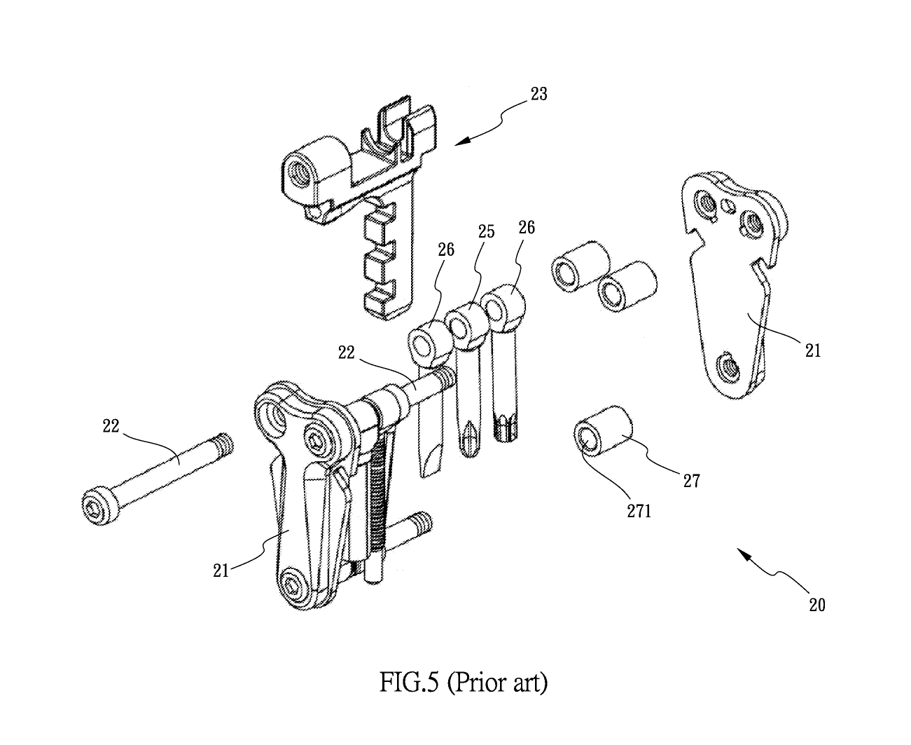

FIG. 6 shows the steps of the method of the present invention;

FIG. 7 shows the first step of the method of the present invention;

FIG. 8 shows the second step of the method of the present invention;

FIG. 9 shows the third step of the method of the present invention;

FIG. 10 is a plan view to show the bicycle folding tool pack made by the method of the present invention;

FIG. 11 shows the steps of another embodiment of the method of the present invention;

FIG. 12 shows that the folding tool is set and formed in the method in FIG. 11, and

FIG. 13 is a plan view to show the bicycle folding tool pack made by the method of the present invention as disclosed in FIG. 11.

### DETAILED DESCRIPTION OF THE PREFERRED EMBODIMENT

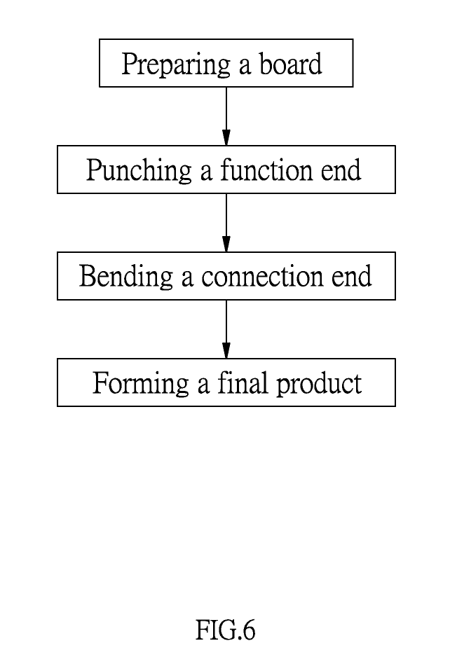

Referring to FIG. 6, the method of the present invention comprises the following steps:

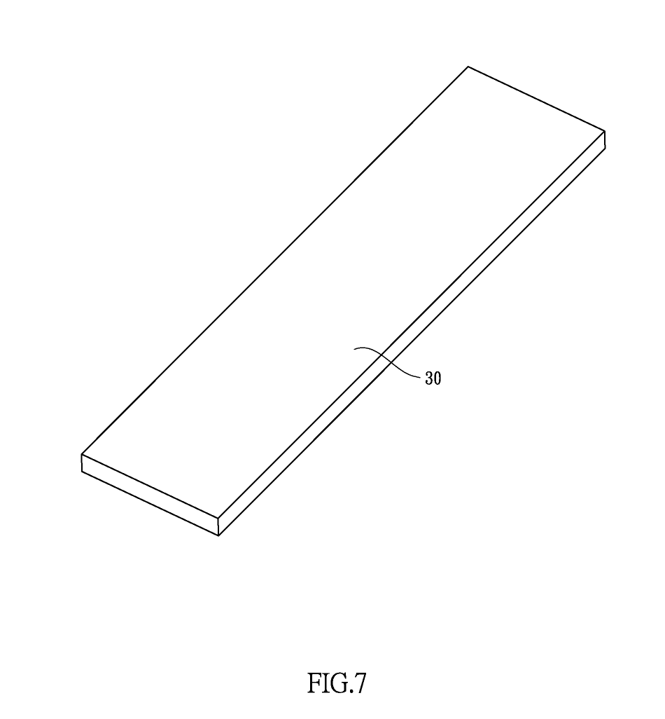

A step of preparing, wherein a board 30 with a pre-set length is prepared. The board 30 is an elongate board as shown in FIG. 7;

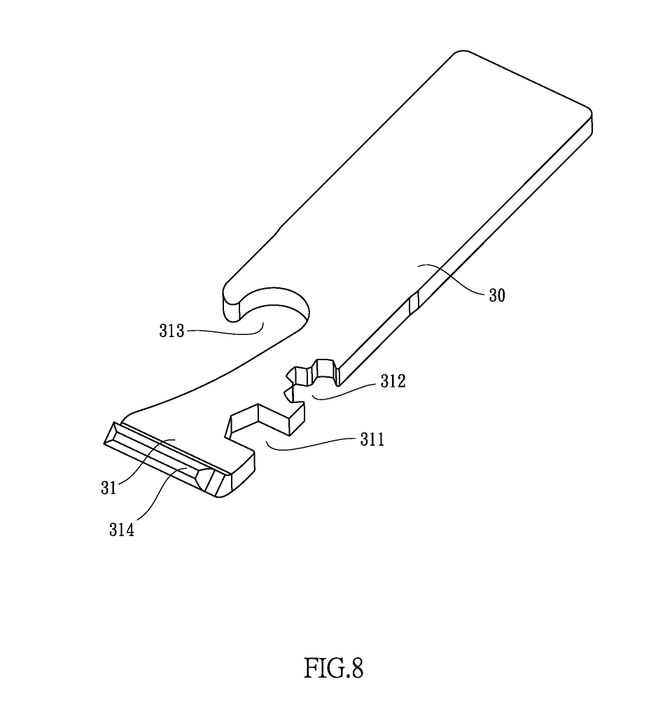

A step of punching, wherein the first end of the board 30 is punched to form the function end 31 which meets the requirements of the users such as the spoke holes 311, 312, the can opener, and the tire removing plate 314 as shown in FIG. 8. The board 30 with the function end 31 is a semi-finished product which has the function end 31 formed at the first end thereof.

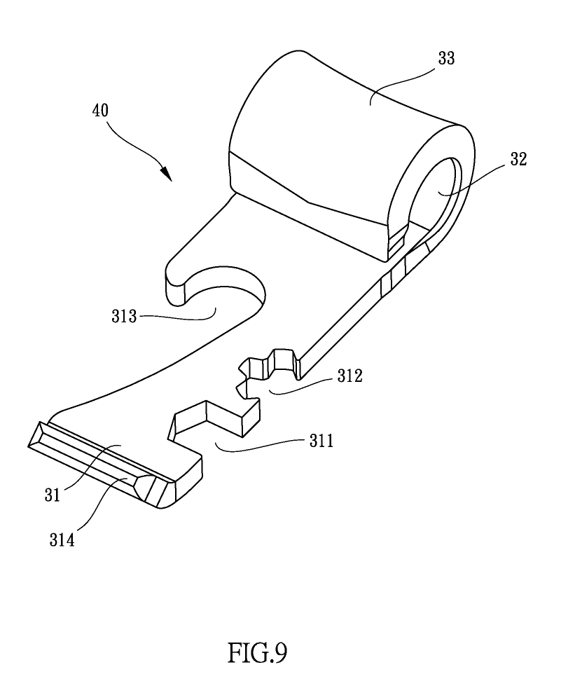

A step of bending, wherein the second end of the semi-finished product is bent to form a connection end 33 which has a hole 32 defined therethrough as shown in FIG. 9.

A step of forming a final product, wherein the final product is formed with the function end 31 and the connection end 33 on two ends thereof.

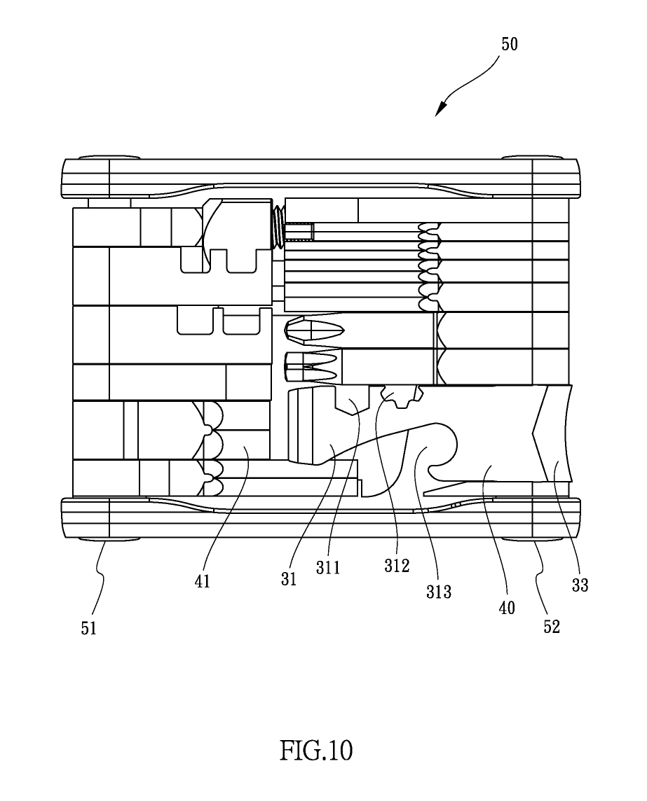

The length of each board 30 is fixed so that the final product of the folding tool has the consistent size so that when multiple of the folding tools are assembled to be a bicycle folding tool pack 50 as shown in FIG. 10, the folding tools are well positioned and the folding tools are made according to the user's needs. Besides, the board 30 makes the folding tool to be light in weight.

The function end 31 of the folding tool is made by way of punching so that the shape and size can be made as desired. A larger size of the folding tools can be easily manufactured with the consistent length.

When the folding tool pack 50 includes two pivots 51, 52, the folding tools are able to be managed to save space. For example, when a folding tool 40 having a longer length is connected to the pivot 52, then another folding tool 41 connected to the other pivot 51 that is located corresponding to the folding tool 40 is a shorter tool. By this arrangement, the folding tools can be arranged within a limited space.

The hole 32 in the connection end 33 is made by bending the board 30 so that no extra drilling machine, no separation tube, and no complicated machining control are needed. The connection end 33 of each folding tool is identical.

The length of the folding tools 40 can be made as needed so that the folding tools 40 are assembled to the bicycle folding tool pack in an organized way.

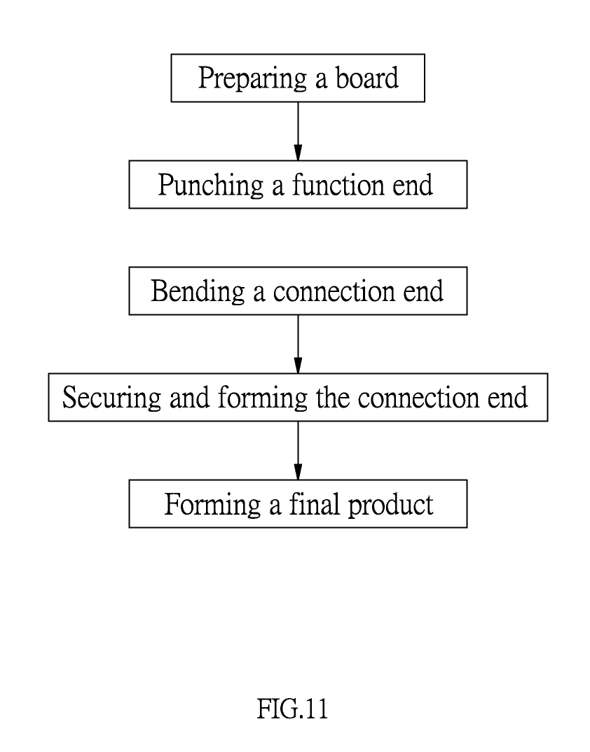

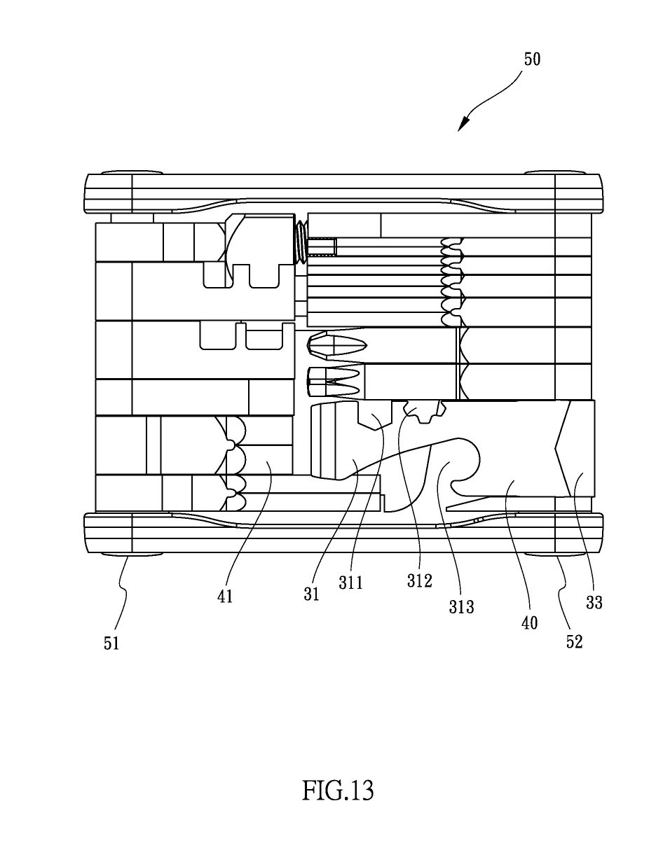

Alternatively, as shown in FIG. 11, for a second embodiment of the present invention, the method of the present invention further comprises a sub-step of punching by using molds after the step of bending, the molds secure and form the final product with consistent shape and structure. Specifically, because the connection end 33 after the step of bending includes slightly deformation which makes the two ends of the connection end 33 slightly being bent upward. Therefore, by the sub-step of punching, the hole 32 and the connection end 33 are well shaped as shown in FIG. 13.

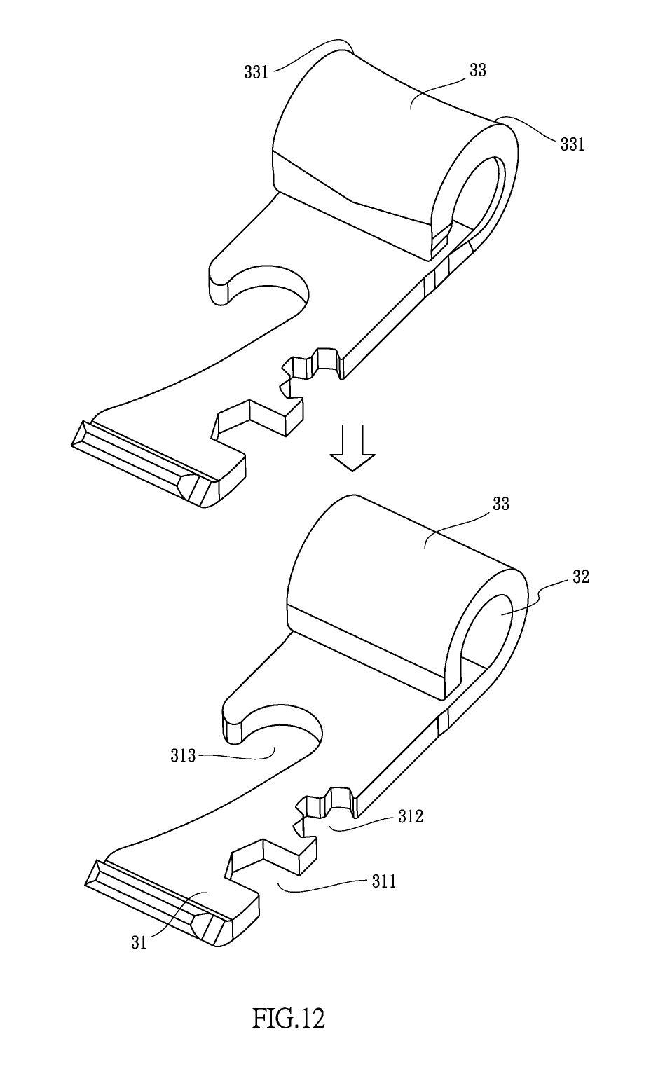

Furthermore, by the sub-step of punching, the strength of the hole 32 and the connection end 33 are well established as shown in FIG. 12.

While we have shown and described the embodiment in accordance with the present invention, it should be clear to those skilled in the art that further embodiments may be made without departing from the scope of the present invention.

What is claimed is:

1. A method for making bicycle folding tools, comprising:
a step of preparing: preparing a board with a pre-set length;
a step of punching: punching a first end of the board to form a function end, the board with the function end being a semi-finished product which has the function end formed at a first end thereof;
a step of bending: bending a second end of the semi-finished product to form a connection end which has a hole defined therethrough, and
a step of forming a final product: a final product being formed with the function end and the connection end on two ends thereof.

2. The method as claimed in claim 1 further comprising a sub-step of punching by using molds after the step of bending, the molds secure and form the final product with consistent shape and structure.
